(19) United States
(12) Patent Application Publication
(10) Pub. No.: US 2024/0363883 A1
(43) Pub. Date: Oct. 31, 2024

(54) CARRIER AND METHOD FOR ALIGNMENT USING THE SAME

(71) Applicant: SK ON CO., LTD., Seoul (KR)

(72) Inventors: Yu Ri SONG, Daejeon (KR); Do Young KIM, Daejeon (KR)

(21) Appl. No.: 18/637,472

(22) Filed: Apr. 17, 2024

(30) Foreign Application Priority Data
Apr. 26, 2023 (KR) 10-2023-0054673
Oct. 18, 2023 (KR) 10-2023-0139293

(51) Int. Cl. H01M 10/04

(52) U.S. Cl. CPC H01M 10/0404

(57) ABSTRACT

The present disclosure provides a carrier and a method for alignment using the same. The alignment method of the present disclosure may acquire images of the carrier by an optical system, analyze an alignment state of the optical system with respect to the carrier, and align the optical system based on the alignment state.

### CROSS-REFERENCE TO RELATED APPLICATIONS

This patent document claims the priority and benefits of Korean Patent Application Nos. 10-2023-0054673 filed on Apr. 26, 2023, and 10-2023-0139293 filed on Oct. 18, 2023, the entire contents of which are incorporated herein by reference as part of the disclosure of this application.

### BACKGROUND OF THE INVENTION

### 1. Field of the Invention

The present disclosure relates to a carrier and a method for alignment using the same. The alignment method of the present disclosure may align an optical system or battery cell by acquiring images of a carrier using the optical system and then analyzing the images.

### 2. Description of the Related Art

When manufacturing a battery cell, equipment to inspect an appearance of the battery cell is used. The equipment used to inspect the appearance of battery cell may be referred to as an optical system. The optical system may inspect the appearance of battery cell which are mounted and transferred on a carrier. The optical system may include cameras, scanners, lighting and the like.

Locations of the battery cell, the carrier or the optical system may be misaligned due to vibration that occurs during transferring the battery cell, compressed air, or friction in a driving unit.

### PRIOR ART DOCUMENT

### Patent Document

(Patent Document 1) Korean Patent Laid-Open Publication No. 10-2016-0049709

### SUMMARY OF THE INVENTION

The disclosed technology can be implemented in some embodiments to provide a carrier which can determine an alignment state of an optical system or battery cell.

The disclosed technology can be implemented in some embodiments to provide a method capable of aligning an optical system or battery cell by acquiring images of a carrier on which the battery cell is mounted, and determining an alignment state of the optical system or battery cell from the images.

According to an aspect of the present disclosure, there is provided a an alignment device including: a carrier; and an optical system disposed above the carrier to acquire images of an upper surface of the carrier within a field of view (FOV), wherein the carrier includes: a carrier body formed to extend in a left-right direction; and a marking member disposed on an upper surface of the carrier body, wherein edges of the marking member are formed so that at least a portion thereof overlaps with boundaries of the FOV in a normal state, and the normal state is a state where the optical system is located at a preset location with respect to the carrier.

According to an aspect of the present disclosure, there is provided an alignment method including: an image acquisition step of, by an optical system, acquiring images of a carrier; a location extraction step of, by a controller, extracting a location of a marking member of the carrier from the images; a location analysis step of, by the controller, determine an alignment state of the optical system by analyzing the location of the marking member compared to boundaries of a field of view (FOV) of the optical system; and an adjustment step of, by an adjustment unit, adjusting the location of the optical system according to the alignment state of the optical system, wherein the alignment state of the optical system includes: a normal state where the optical system is located at a preset location with respect to the carrier; and an abnormal state where the optical system deviates from the preset location with respect to the carrier.

According to an embodiment of the present disclosure, the alignment state of the optical system or battery cell may be determined.

According to an embodiment of the present disclosure, the optical system or battery cell may be aligned by acquiring images of the carrier on which the battery cell is mounted, and determining the alignment state of the optical system or battery cell from the images.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a view illustrating equipment 10 according to an embodiment of the present disclosure;

FIG. 2 is a view illustrating the equipment 10 of FIG. 1 as viewed from the top;

FIG. 3 is an enlarged view of a portion A in FIG. 2;

FIG. 4 is a view illustrating when the alignment state of a carrier 200, a battery cell 300, and an optical system 400 of FIG. 1 is a normal state;

FIG. 5 is a view illustrating a state where the optical system 400 is moved in one direction compared to the normal state;

FIG. 6 is a view illustrating a state where the optical system 400 is rotated compared to the normal state;

FIG. 7 is a view illustrating a state where the battery cell 300 is moved in one direction compared to the normal state;

FIG. 8 is a view illustrating a state where the battery cell 300 is rotated compared to the normal state;

FIG. 9 is a view illustrating the battery cell 300 according to an embodiment of the present disclosure;

FIG. 10 is a block diagram illustrating the optical system 400, a controller 500, and a notification unit 600 according to an embodiment of the present disclosure;

FIG. 11 is a block diagram illustrating the optical system 400, the controller 500, and an adjustment unit 700 according to an embodiment of the present disclosure; and

FIG. 12 is a flowchart illustrating an alignment method (S10) according to an embodiment of the present disclosure.

### DETAILED DESCRIPTION OF THE INVENTION

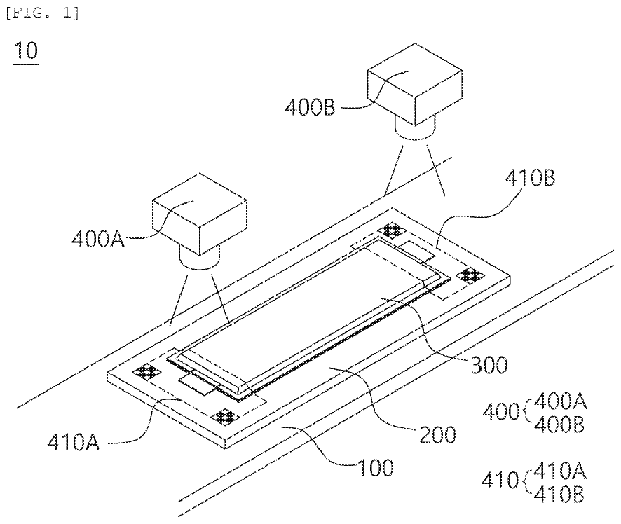

Hereinafter, exemplary embodiments of the present disclosure will be described in detail with reference to FIGS. 1 to 11. However, these embodiments are merely an example, and the present disclosure is not limited to the specific embodiments described as the example.

When it is referred that a component “overlaps” with another component, it may mean that the location of at least a portion of the component is the same as the location of at least a portion of the other component, but may also mean that a difference between the location of at least a portion of the component and the location of at least a portion of the other component falls within a preset error range.

When it is referred that a component “does not overlap” with another component, it may mean that the location of at least a portion of the component is not the same as the location of at least a portion of the other component, but also may mean that a difference between the location of at least a portion of the component and the location of at least a portion of the other component deviates from the preset error range.

When the statement that a component “overlaps” with another component means that the difference between the location of at least a portion of the component and the location of at least a portion of the other component falls within the preset error range, the statement that a component “does not overlap” with another component may mean that the difference between the location of the component and the locations of other component deviates from the preset error range.

FIG. 1 is a view illustrating equipment 10 according to an embodiment of the present disclosure.

The equipment 10 may include a rail 100 and a carrier 200 mounted on an upper surface of the rail 100. The carrier 200 may be a linear motion system (LMS) carrier. The rail 100 may transfer the carrier 200 in one direction. For example, the rail 100 may be formed to extend in a left-right direction. For example, the rail 100 may transfer the carrier 200 from left to right. The carrier 200 may be aligned by the rail 100.

For example, the carrier 200 may be formed to extend in the left-right direction. For example, a length direction of the carrier 200 may be parallel to the left-right direction, a width direction of the carrier 200 may be parallel to a front-back direction, and a height direction of the carrier 200 may be parallel to a vertical direction.

The battery cell 300 may be mounted on the upper surface of the carrier 200. For example, the battery cell 300 may be formed to extend in the left-right direction. A left side of the battery cell 300 may be mounted on an upper left surface of the carrier 200. A right side of the battery cell 300 may be mounted on an upper right surface of the carrier 200.

The equipment 10 may include an optical system 400. The optical system 400 may be disposed above the rail 100. The optical system 400 may be disposed above the carrier 200. The optical system 400 may face the upper surface of the carrier 200. The optical system 400 may be disposed above the battery cell 300.

The optical system 400 may acquire images of the carrier 200 and the battery cell 300. The location where the optical system 400 acquires the images of the carrier 200 and the battery cell 300 may be a location where the carrier 200 moving along the rail 100 stops.

The equipment 10 may include a plurality of optical systems 400. The equipment 10 may include a first optical system 400A and a second optical system 400B. The first optical system 400A and the second optical system 400B may be disposed to be spaced apart from each other in the left-right direction.

For example, the first optical system 400A may be disposed above the left side of the carrier 200. For example, the first optical system 400A may be disposed above the left side of the battery cell 300. A field of view (hereafter referred to as “FOV”) of the first optical system 400A may be referred to as a first FOV 410A.

The first FOV 410A may be formed on the left side of the carrier 200. The first FOV 410A may include at least a portion of the left side of the carrier 200. The first FOV 410A may include at least a portion of the left side of the battery cell 300. The first optical system 400A may acquire images of the left side of the carrier 200 and the left side of the battery cell 300.

For example, the second optical system 400B may be disposed above the right side of the carrier 200. For example, the second optical system 400B may be disposed above the right side of the battery cell 300. The FOV of the second optical system 400B may be referred to as a second FOV 410B.

The second FOV 410B may be formed on the right side of the carrier 200. The second FOV 410B may include at least a portion of the right side of the carrier 200. The second FOV 410B may include at least a portion of the right side of the battery cell 300. The second optical system 400B may acquire images of the right side of the carrier 200 and the right side of the battery cell 300.

The optical system 400 may mean at least one of the first optical system 400A and the second optical system 400B. The FOV 410 may mean at least one of the first FOV 410A and the second FOV 410B.

An alignment device may include the carrier 200 and the optical system 400. Alignment states of the battery cell 300 and the optical system 400 may be determined using the carrier 200 and the optical system 400.

The alignment state of the optical system 400 may include a normal state where the optical system 400 is located at a preset location with respect to the carrier 200. The alignment state of the optical system 400 may include an abnormal state where the optical system 400 deviates from the preset location with respect to the carrier 200.

The alignment state of the battery cell 300 may include a normal state where the battery cell 300 is located at a preset location with respect to the carrier 200. The alignment state of the battery cell 300 may include an abnormal state where the battery cell 300 deviates from the preset location with respect to the carrier 200.

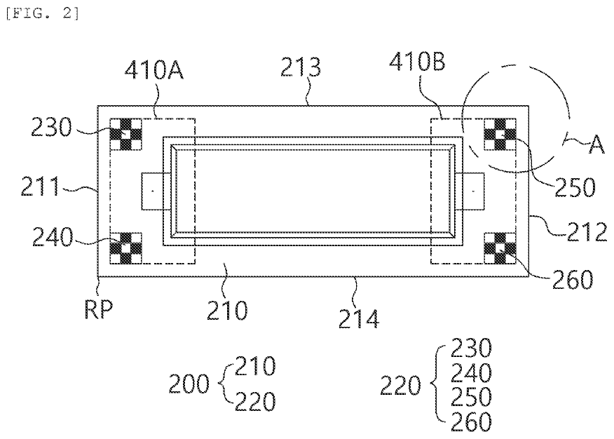

FIG. 2 is a view illustrating the equipment 10 of FIG. 1 as viewed from the top.

As shown in FIG. 2, the carrier 200 may include a carrier body 210. A length direction of the carrier body 210 may be parallel to the left-right direction. A width direction of the carrier body 210 may be parallel to the front-back direction. A height direction of the carrier body 210 may be parallel to the vertical direction.

The carrier body 210 may include a carrier left end 211. The carrier left end 211 may be formed to extend in the front-back direction. The carrier body 210 may include a carrier right end 212. The carrier right end 212 may be disposed on the right side of the carrier left end 211. The carrier right end 212 may be formed to extend in the front-back direction. The carrier left end 211 may extend in a direction parallel to the direction in which the carrier right end 212 extends.

The carrier body 210 may include a carrier front end 213. The carrier front end 213 may be formed to extend from a front tip of the carrier left end 211 to a front tip of the carrier right end 212. The carrier front end 213 may be formed to extend in the left-right direction. The carrier body 210 may include a carrier rear end 214. The carrier rear end 214 may be formed to extend from a rear tip of the carrier left end 211 to a rear tip of the carrier right end 212. The carrier rear end 214 may be formed to extend in the left-right direction. The carrier front end 213 may extend in a direction parallel to the direction in which the carrier rear end 214 extends.

The carrier left end 211, the carrier right end 212, the carrier front end 213 and the carrier rear end 214 may form a periphery of the carrier body 210. For example, the periphery of the carrier body 210 may have a square shape.

The carrier 200 may include a marking member 220. The marking member 220 may be disposed on the upper surface of the carrier body 210. The marking member 220 may include calibration glass. The marking member 220 may be at least one of glass, sheet, paper, plate, board, marking, film, sticker, mask, imprint, tag and print.

The carrier 200 may include a plurality of marking members 220. The carrier 200 may include a first marking member 230, a second marking member 240, a third marking member 250 and a fourth marking member 260. The marking member 220 may mean at least one of the first marking member 230, the second marking member 240, the third marking member 250 and the fourth marking member 260.

The marking member 220 may be disposed to be spaced apart from the periphery of the carrier body 210.

The first marking member 230 may be disposed on the front left side of the upper surface of the carrier body 210 with being spaced apart from the carrier left end 211 and the carrier front end 213. The second marking member 240 may be disposed on the rear left side of the upper surface of the carrier body 210 with being spaced apart from the carrier left end 211 and the carrier rear end 214.

The first marking member 230 and the second marking member 240 may be located within the first FOV 410A. The first marking member 230 may be located on the front left side of the first FOV 410A. The second marking member 240 may be located on the rear left side of the first FOV 410A. The first marking member 230 and the second marking member 240 may be disposed to be spaced apart from each other in the front-back direction. The first optical system 400A (see FIG. 1) may acquire images of the first marking member 230 and the second marking member 240.

The third marking member 250 may be disposed on the front right side of the upper surface of the carrier body 210 with being spaced apart from the carrier right end 212 and the carrier front end 213. The fourth marking member 260 may be disposed on the rear right side of the upper surface of the carrier body 210 with being spaced apart from the carrier right end 212 and the carrier rear end 214.

The third marking member 250 and the fourth marking member 260 may be located in the second FOV 410B. The third marking member 250 may be located on the front right side of the second FOV 410B. The fourth marking member 260 may be located on the rear right side of the second FOV 410B. The third marking member 250 and the fourth marking member 260 may be disposed to be spaced apart from each other in the front-back direction. The second optical system 400B (see FIG. 1) may acquire images of the third marking member 250 and the fourth marking member 260.

Edges of the marking member 220 may correspond to boundaries of the FOV 410. The edges of the marking member 220 may be formed to overlap with the boundaries of the FOV 410.

For example, a lower left tip of the carrier 200 may be a reference point RP. For example, the lower tip of the carrier left end 211 may be the reference point RP. For example, the left end tip of the carrier rear end 214 may be the reference point RP.

The marking member 220 may be disposed to be spaced at a predetermined distance from the reference point RP. The marking member 220 may be disposed at a preset location with respect to the reference point RP.

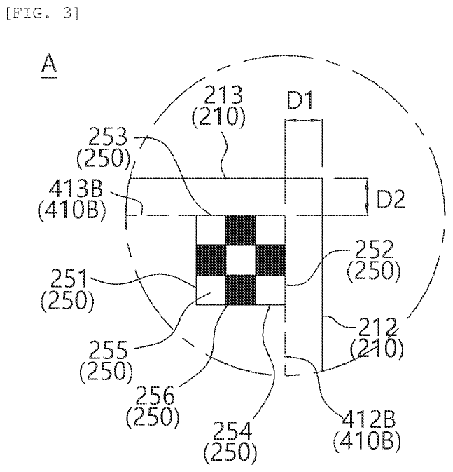

FIG. 3 is an enlarged view of a portion A in FIG. 2. In FIG. 3, the shape of the marking member 220 will be described using the third marking member 250 as an example. In FIG. 3, locational relationships between the marking member 220, the carrier body 210 and the FOV 410 will be described using the third marking member 250 as an example.

The third marking member 250 may include a third marking member left end 251. The third marking member left end 251 may be formed to extend in the front-back direction. The third marking member left end 251 may extend in a direction parallel to the direction in which the carrier right end 212 extends.

The third marking member 250 may include a third marking member right end 252. The third marking member right end 252 may be disposed on the right side of the third marking member left end 251. The third marking member right end 252 may be formed to extend in the front-back direction. The third marking member right end 252 may extend in a direction parallel to the direction in which the carrier right end 212 extends.

The third marking member 250 may include a third marking member front end 253. The third marking member front end 253 may be formed to extend from a front tip of the third marking member left end 251 to a front tip of the third marking member right end 252. The third marking member front end 253 may extend in a direction parallel to the direction in which the carrier front end 213 extends.

The third marking member 250 may include a third marking member rear end 254. The third marking member rear end 254 may be formed to extend from a rear tip of the third marking member left end 251 to a rear tip of the third marking member right end 252. The third marking member rear end 254 may extend in a direction parallel to the direction in which the carrier front end 213 extends.

The third marking member left end 251, the third marking member right end 252, the third marking member front end 253 and the third marking member rear end 254 may form the edges of the third marking member 250. For example, the edges of the third marking member 250 may have a square shape as whole. The edges of the third marking member 250 may be distinguished from the upper surface of the carrier 200.

The third marking member right end 252 may be disposed to be spaced apart from the carrier right end 212 by a first distance D1. The third marking member front end 253 may be disposed to be spaced apart from the carrier front end 213 by a second distance D2. For example, the first distance D1 and the second distance D2 may be the same.

The second FOV 410B may include a second FOV right end 412B. The second FOV right end 412B may be formed to extend in the front-back direction. The second FOV 410B may include a second FOV front end 413B. The second FOV front end 413B may be formed to extend leftward from the front tip of the second FOV right end 412B.

Although not shown in FIG. 3, the second FOV 410B may include a second FOV left end extending downward from a left tip of the second FOV front end 413B. The second FOV 410B may include a second FOV rear end extending leftward from a rear tip of the second FOV right end 412B.

The second FOV right end 412B, the second FOV front end 413B, the second FOV left end and the second FOV rear end may form boundaries of the second FOV 410B. Each of the second FOV right end 412B, the second FOV front end 413B, the second FOV left end and the second FOV rear end may be one of line segments constituting the boundaries of the second FOV 410B. For example, the boundaries of the second FOV 410B may have a square shape as whole.

A state where the carrier 200 and the optical system 400 (see FIG. 1) are disposed at a preset location may be referred to as a normal state. In the normal state, at least a portion of the second FOV right end 412B may overlap with the third marking member right end 252. In the normal state, at least a portion of the second FOV front end 413B may overlap with the third marking member front end 253. In the normal state, the third marking member 250 may be located within the second FOV 410B.

The third marking member 250 may include a plurality of figures 255 and 256. The plurality of figures 255 and 256 may include a first figure type or a second figure type. The brightness of the first figure type may be different from the brightness of the second figure type. The brightness of the first figure type may be higher than the brightness of the second figure type. For example, the first figure type and the second figure type may have a square shape, respectively.

A figure corresponding to the first figure type may be referred to as the first FIG. 255. A figure corresponding to the second figure type may be referred to as the second FIG. 256.

The third marking member 250 may include a plurality of first figures 255 and a plurality of second figures 256. Each of the plurality of first figures 255 may be referred to as a unit figure of the first figures 255. Each of the plurality of second figures 256 may be referred to as a unit figure of the second figures 256.

The third marking member 250 may be formed by alternately arranging the first figures 255 and the second figures 256. For example, the third marking member 250 may be formed in the shape of a checkerboard by arranging the unit figures of the first FIG. 255 and the unit figures of the second FIG. 256 which have different brightness.

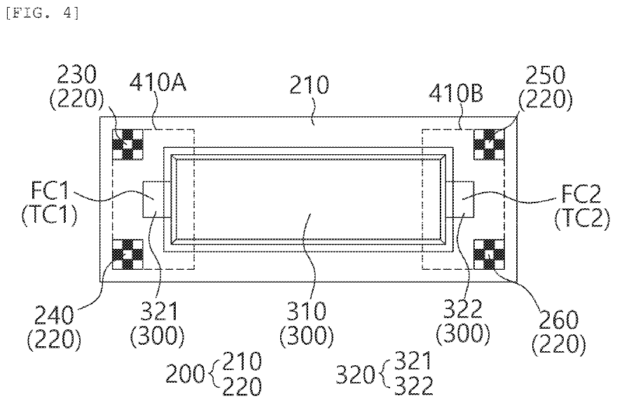

As shown in FIG. 4, the battery cell 300 may be disposed in the center of the carrier 200.

The battery cell 300 may include a cell body 310. A length direction of the cell body 310 may be the left-right direction. A width direction of the cell body 310 may be the front-back direction.

The battery cell 300 may include an electrode tab 320. The electrode tab 320 may be formed to protrude from the cell body 310. The electrode tab 320 may mean an electrode lead.

The battery cell 300 may include a plurality of electrode tabs 320. The battery cell 300 may include a first electrode tab 321 and a second electrode tab 322. The first electrode tab 321 may be formed to protrude from the left side of the cell body 310. The second electrode tab 322 may be formed to protrude from the right side of the cell body 310.

The first electrode tab 321 may be disposed between the first marking member 230 and the second marking member 240. The second electrode tab 322 may be disposed between the third marking member 250 and the fourth marking member 260.

FIG. 4 is a view illustrating a case where alignment states of the carrier 200, the battery cell 300 and the optical system 400 of FIG. 1 are the normal state. When determining the alignment states of the carrier 200, the battery cell 300 and the optical system 400, their states may be determined based on when viewed the carrier 200, the battery cell 300 and the optical system 400 from the top. For example, the alignment states of the carrier 200, the battery cell 300 and the optical system 400 may be determined based on the images of the carrier 200 and the battery cell 300 acquired by the optical system 400.

In the normal state, two marking members 220 may be included within the FOV 410 (see FIG. 1) of each optical system 400 (see FIG. 1). In the normal state, at least two of the line segments constituting the boundaries of each FOV 410 may overlap with the edges of one marking member 220. Among the line segments constituting the boundaries of each FOV 410, at least three line segments may overlap with the edges of the two marking members 220.

Among the edges of the marking member 220, portions adjacent to the edges of the carrier body 210 may be referred to as outer edges. Among the edges of the marking member 220, portions which directly face the edges of the carrier body 210 may be referred to as outer edges. Among the edges of the marking member 220, portions which face other marking members 220 may be referred to as inner edges.

For example, the outer edges of the first marking member 230 may be left end and front end of the first marking member 230. For example, the inner edges of the first marking member 230 may be right end and rear end of the first marking member 230.

In the normal state, the boundaries of each FOV 410 may overlap with the outer edges of the marking member 220. In the normal state, the boundaries of each FOV 410 may overlap with the outer edges of the two marking members 220.

By comparing the locations of the boundaries of the FOV 410 (see FIG. 1) with the locations of the edges of the marking member 220, the locational relationship between the optical system 400 (see FIG. 1) and the carrier 200 may be analyzed.

In the normal state, the first marking member 230 and the second marking member 240 may be located within the first FOV 410A. In the normal state, at least three of the line segments constituting the boundaries of the first FOV 410A may overlap with the edges of the first marking member 230 or the edges of the second marking member 240.

In the normal state, at least two of the line segments constituting the boundaries of the first FOV 410A may overlap with the edges of the first marking member 230. In the normal state, the left end and front end of the first FOV 410A may overlap with the left end and front end of the first marking member 230, respectively.

In the normal state, at least two of the line segments constituting the boundaries of the first FOV 410A may overlap with the edges of the second marking member 240. In the normal state, the left end and rear end of the second FOV 410B may overlap with the left end and rear end of the second marking member 240, respectively.

In the normal state, the third marking member 250 and the fourth marking member 260 may be located within the second FOV 410B. In the normal state, at least three of the line segments constituting the boundaries of the second FOV 410B may overlap with the edges of the third marking member 250 or the edges of the fourth marking member 260.

In the normal state, at least two of the line segments constituting the boundaries of the second FOV 410B may overlap with the edges of the third marking member 250. In the normal state, the right end and rear front of the second FOV 410B may overlap with the right end and front end of the third marking member 250, respectively.

In the normal state, at least two of the line segments constituting the boundaries of the second FOV 410B may overlap with the edges of the fourth marking member 260. In the normal state, the right end and rear end of the second FOV 410B may overlap with the right end and rear end of the fourth marking member 260, respectively.

In the normal state, centers of the FOV 410 (see FIG. 1) of each optical system 400 (see FIG. 1) may overlap with the centers of the electrode tabs 320. By comparing the locations of the centers of the FOV 410 (see FIG. 1) with the locations of the centers of the electrode tabs 320, the locational relationship between the optical system 400 (see FIG. 1) and the battery cell 300 may be analyzed.

The center of the first FOV 410A may be referred to as a first FOV center FC1. The center of the second FOV 410B may be referred to as a second FOV center FC2. The center of the first electrode tab 321 may be referred to as a first electrode tab center TC1. The center of the second electrode tab 322 may be referred to as a second electrode tab center TC2.

In the normal state, the first FOV center FC1 may overlap with the first electrode tab center TC1. In the normal state, the second FOV center FC2 may overlap with the second electrode tab center TC2.

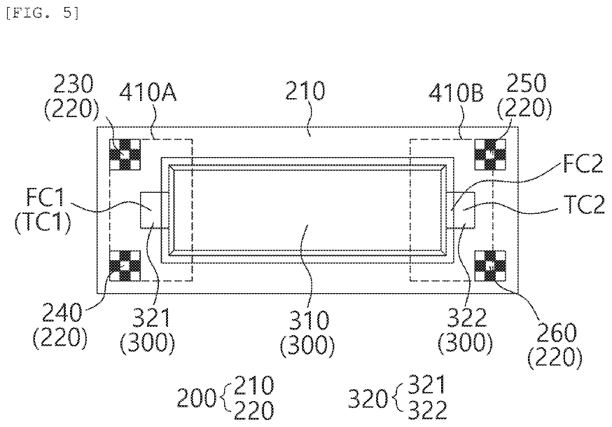

FIGS. 5 to 8 are views illustrating cases where the alignment states of the carrier 200, the battery cell 300 and the optical system 400 in 1 is an abnormal state. The cases where the alignment states of the carrier 200, the battery cell 300 and the optical system 400 of FIG. 1 is the abnormal state are not limited to the cases shown in FIGS. 5 to 10.

FIG. 5 is a view illustrating a state where the optical system 400 (see FIG. 1) is moved in one direction compared to the normal state. FIG. 5 is a view illustrating a state where the second optical system 400B (see FIG. 1) is moved leftward compared to the normal state.

In the abnormal state, at least a portion of the marking member 220 may move out of the FOV 410.

As shown in FIG. 5, in the abnormal state, at least a portion of the third marking member 250 or the fourth marking member 260 may move out of the second FOV 410B.

In the abnormal state, the boundary of the FOV 410 may not overlap with at least a portion of the outer edge of the marking member 220. In the abnormal state, the boundary of the FOV 410 may be spaced apart from at least a portion of the outer edge of the marking member 220.

As shown in FIG. 5, in the abnormal state, the boundary of the second FOV 410B may not overlap with at least a portion of the outer edge of the third marking member 250 or at least a portion of the outer edge of the fourth marking member 260. As shown in FIG. 5, in the abnormal state, the boundary of the second FOV 410B may be spaced apart from at least a portion of the outer edge of the third marking member 250 or at least a portion of the outer edge of the fourth marking member 260.

The front end and rear end of the FOV 410 may be referred to as a longitudinal boundary. The left end and right end of the FOV 410 may be referred to as a widthwise boundary. The front end and rear end of each marking member 220 may be referred to as a longitudinal edge. The left end and right end of each marking member 220 may be referred to as a widthwise edge.

In the abnormal state, if the longitudinal boundary of the FOV 410 overlaps with the longitudinal edge of the marking member 220, but the widthwise boundary of the FOV 410 does not overlap with the widthwise edge of the marking member 220, it may be a state where the optical system 400 (see FIG. 1) is moved in the length direction of the carrier 200.

At this time, if at least a portion of the marking member 220 is located outside the FOV 410 and the battery cell 300 is located within the FOV 410, it may be a state where the optical system 400 (see FIG. 1) is moved toward the center of the carrier 200.

At this time, if at least a portion of the marking member 220 is located outside the FOV 410 and at least a portion of the FOV 410 deviates from the carrier 200, it may be a state where the optical system 400 (see FIG. 1) is moved toward the outside of the carrier 200.

By analyzing a difference between the locations of the edges of the marking member 220 and the locations of the boundaries of the FOV 410, a distance in which the optical system 400 (see FIG. 1) is moved compared to the normal state may be derived.

As shown in FIG. 5, the front end of the second FOV 410B may overlap with the front end of the third marking member 250, and the rear end of the second FOV 410B may overlap with the rear end of the fourth marking member 260. In addition, the right end of the second FOV 410B may be located on the left side of the right end of the third marking member 250 and the right end of the fourth marking member 260. At this time, it may be determined that the second optical system 400B (see FIG. 1) has been moved leftward compared to the normal state.

If the second optical system 400B (see FIG. 1) is moved compared to the normal state, the second FOV center FC2 may not overlap with the second electrode tab center TC2. As shown in FIG. 5, the second FOV center FC2 may be located on the left side of the second electrode tab center TC2.

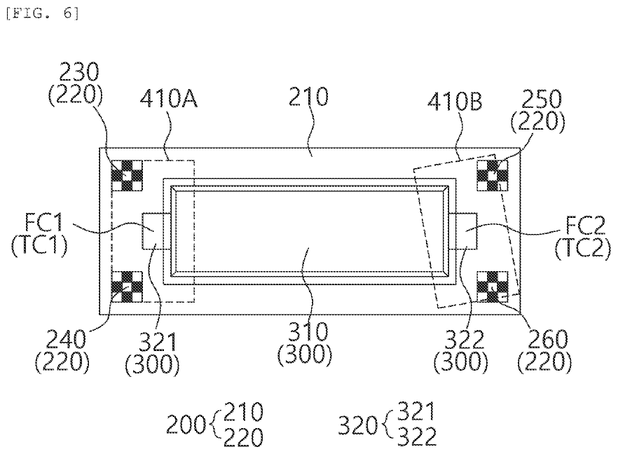

FIG. 6 is a view illustrating a state where the optical system 400 (see FIG. 1) is rotated compared to the normal state. FIG. 6 is a view illustrating a state where the second optical system 400B (see FIG. 1) is rotated in a counterclockwise direction compared to the normal state.

In the abnormal state, at least a portion of the marking members 220 may move out of the FOV 410.

As shown in FIG. 6, in the abnormal state, at least a portion of the third marking member 250 or the fourth marking member 260 may move out of the second FOV 410B. As shown in FIG. 6, in the abnormal state, the right side of the third marking member 250 and the rear side of the fourth marking member 260 may move out of the second FOV 410B. At this time, it may be determined that the second optical system 400B (see FIG. 1) has been rotated in the counterclockwise direction compared to the normal state.

In contrast, the front side of the third marking member 250 and the right side of the fourth marking member 260 may move out of the second FOV 410B. At this time, it may be determined that the second optical system 400B (see FIG. 1) is rotated in a clockwise direction compared to the normal state.

In the abnormal state, the boundary of the FOV 410 may not overlap with the outer edge of the marking member 220. In the abnormal state, at least a portion of the boundary of the FOV 410 may form an angle with at least a portion of the edge of the marking member 220.

As shown in FIG. 6, in the abnormal state, at least a portion of the boundary of the second FOV 410B may form an angle with at least a portion of the edge of the third marking member 250 or at least a portion of the edge of the fourth marking member 260.

As shown in FIG. 6, in the abnormal state, the right end of the second FOV 410B may form an angle with the longitudinal edge of the third marking member 250, and the rear end of the second FOV 410B may form an angle with the widthwise edge of the fourth marking member 260. At this time, it may be determined that the second optical system 400B (see FIG. 1) has been rotated in the counterclockwise direction compared to the normal state.

In contrast, the right end of the second FOV 410B may form an angle with the widthwise edge of the third marking member 250, and the rear end of second FOV 410B may form an angle with the longitudinal edge of the fourth marking member 260. At this time, it may be determined that the second optical system 400B (see FIG. 1) has been rotated in the clockwise direction compared to the normal state.

If the second optical system 400B (see FIG. 1) is rotated in place compared to the normal state, the second FOV center FC2 may overlap with the second electrode tab center TC2. As shown in FIG. 6, the second FOV center FC2 may overlap with the second electrode tab center TC2.

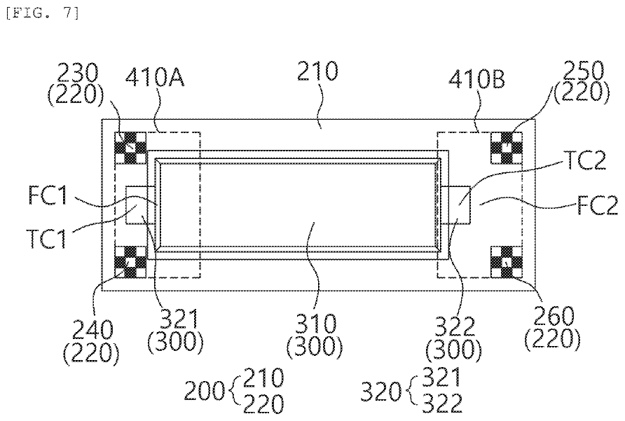

FIG. 7 is a view illustrating a state where the battery cell 300 is moved in one direction compared to the normal state. FIG. 7 is a view illustrating a state where the battery cell 300 is moved leftward compared to the normal state.

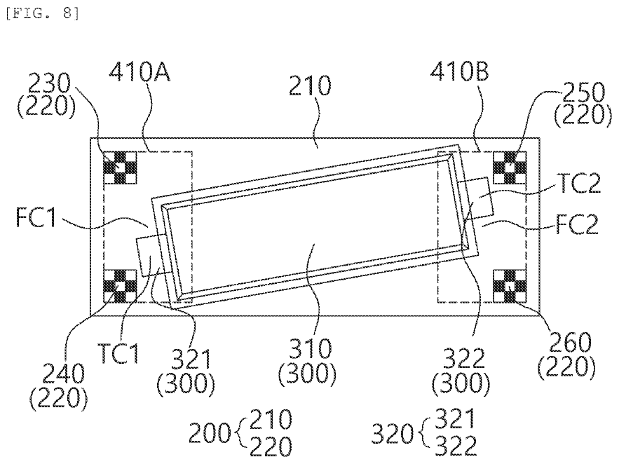

FIG. 8 is a view illustrating a state where the battery cell 300 is rotated compared to the normal state. FIG. 8 is a view illustrating a state where the battery cell 300 is rotated in the counterclockwise direction compared to the normal state.

In the abnormal state, the electrode tab centers TC1 and TC2 may not overlap with the FOV centers FC1 and FC2. In the abnormal state, the electrode tab centers TC1 and TC2 may deviate from the FOV centers FC1 and FC2.

If at least a portion of the boundary of the FOV 410 overlaps with the outer edge of the two marking members 220, and the electrode tab centers TC1 and TC2 do not overlap with the FOV centers FC1 and FC2, it may be determined that the battery cell 300 has been moved compared to the normal state.

As shown in FIG. 7, the first electrode tab center TC1 may not overlap with the first FOV center FC1. The second electrode tab center TC2 may not overlap with the second FOV center FC2.

As shown in FIG. 7, the first electrode tab center TC1 may deviate leftward from the first FOV center FC1. The second electrode tab center TC2 may deviate leftward from the second FOV center FC2. At this time, it may be determined that the battery cell 300 has been moved leftward compared to the normal state.

As shown in FIG. 8, the first electrode tab center TC1 may not overlap with the first FOV center FC1. The second electrode tab center TC2 may not overlap with the second FOV center FC2.

As shown in FIG. 8, the first electrode tab center TC1 may deviate rearward from the first FOV center FC1. The second electrode tab center TC2 may deviate forward from the second FOV center FC2. At this time, it may be determined that the battery cell 300 has been rotated in the counterclockwise direction compared to the normal state.

In contrast, the first electrode tab center TC1 may deviate forward from the first FOV center FC1. The second electrode tab center TC2 may deviate rearward from the second FOV center FC2. At this time, it may be determined that the battery cell 300 has been rotated in the clockwise direction compared to the normal state.

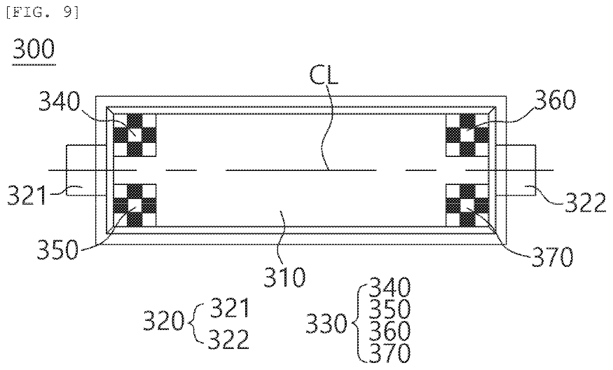

FIG. 9 is a view illustrating the battery cell 300 according to an embodiment of the present disclosure.

A center line CL extends in the left-right direction, and may be a line crossing the center of the battery cell 300. The battery cell 300 may be formed symmetrically in the front-back direction with respect to the center line CL.

Alternatively, the center line CL extends in the left-right direction, and may be a line crossing the center of the electrode tab 320. The electrode tab 320 may be formed symmetrically in the front-back direction with respect to the center line CL. In other words, the electrode tab centers TC1 and TC2 may be located on the center line CL.

The battery cell 300 may include a cell marking member 330. The cell marking member 330 may be formed identically to the marking member 220 (see FIGS. 2 and 3). The cell marking member 330 may be disposed on the upper surface of the cell body 310.

The battery cell 300 may include a plurality of cell marking members 330. The battery cell 300 may include a first cell marking member 340, a second cell marking member 350, a third cell marking member 360 and a fourth cell marking member 370. The cell marking member 330 may mean at least one of the first cell marking member 340, the second cell marking member 350, the third cell marking member 360 and the fourth cell marking member 370.

The first cell marking member 340 may be disposed on the front left side of the upper surface of the cell body 310. The second cell marking member 350 may be disposed on the rear left side of the upper surface of the cell body 310. The first cell marking member 340 and the second cell marking member 350 may be disposed to be spaced apart from each other in the front-back direction. The first cell marking member 340 and the second cell marking member 350 may be disposed in symmetrical locations with respect to the center line CL. In other words, the center line CL may be disposed between the first cell marking member 340 and the second cell marking member 350.

The third cell marking member 360 may be disposed on the front right side of the upper surface of the cell body 310. The fourth cell marking member 370 may be disposed on the rear right side of the upper surface of the cell body 310. The third cell marking member 360 and the fourth cell marking member 370 may be disposed to be spaced apart from each other in the front-back direction. The third cell marking member 360 and the fourth cell marking member 370 may be disposed in symmetrical locations with respect to the center line CL. In other words, the center line CL may be disposed between the third cell marking member 360 and the fourth cell marking member 370.

The center line CL may be a line crossing the center between the first cell marking member 340 and the second cell marking member 350 and the center between the third cell marking member 360 and the fourth cell marking member 370. In other words, if the locations of the first cell marking member 340, the second cell marking member 350, the third cell marking member 360 and the fourth cell marking member 370 are known, the location of the center line CL may be derived.

Referring to FIGS. 4 to 9, when the FOV centers FC1 and FC2 overlap with the center line CL, it may be determined that the alignment state of the battery cell 300 is a normal state. When the first FOV center FC1 and the second FOV center FC2 overlap with the center line CL, it may be determined that the alignment state of the battery cell 300 is a normal state.

In contrast, if the FOV centers FC1 and FC2 deviate from the center line CL, it may be determined that the alignment state of the battery cell 300 is an abnormal state. If at least one of the first FOV center FC1 and the second FOV center FC2 deviates from the center line CL, it may be determined that the alignment state of the battery cell 300 is an abnormal state.

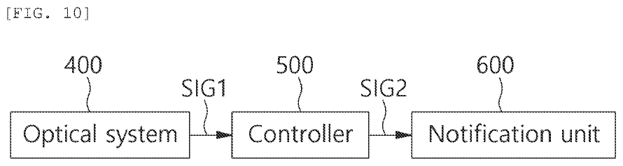

FIG. 10 is a block diagram illustrating the optical system 400, a controller 500, and a notification unit 600 according to an embodiment of the present disclosure. The alignment device may include the controller 500 and the notification unit 600.

Referring to FIGS. 1 to 10, the optical system 400 may photograph the carrier 200 and the battery cell 300. The optical system 400 may acquire images of the carrier 200 and the battery cell 300. The optical system 400 may acquire images of the upper surface of the carrier 200 and the upper surface of the battery cell 300. The images acquired by the optical system 400 may be images within the FOV 410.

The optical system 400 may transmit a first signal SIG1 to the controller 500. The first signal SIG1 may include image information of the carrier 200 and the battery cell 300. Referring to FIG. 3, the first signal SIG1 may include location information of the FOV centers FC1 and FC2.

Referring to FIG. 2, the image information of the carrier 200 may include image information of the carrier body 210 and the marking member 220. The image information of the carrier 200 may include location information of the edges of the marking member 220.

Referring to FIG. 3, the image information of the battery cell 300 may include image information of the electrode tabs 320. The image information of the battery cell 300 may include location information of the electrode tab centers TC1 and TC2.

The controller 500 may analyze the alignment state between the carrier 200, the battery cell 300 and the optical system 400 based on the image information included in the first signal SIG1.

For example, the controller 500 may analyze whether the marking member 220 is included in the image. For example, the controller 500 may analyze an area of the marking member 220 included in the image. For example, the controller 500 may analyze the number of figures 255 and 256 of the marking member 220 included in the image. Through this, the controller 500 may determine the alignment state of the optical system 400.

For example, the controller 500 may compare the locations of the boundaries of the FOV 410 with the locations of the edges of the marking member 220. For example, the controller 500 may analyze whether at least a portion of the boundary of the FOV 410 overlap with the outer edge of the marking member 220. For example, the controller 500 may analyze whether at least a portion of the boundary of the FOV 410 form an angle with at least a portion of the edge of the marking member 220. Through this, the controller 500 may determine the alignment state of the optical system 400.

For example, the controller 500 may compare the locations of the FOV centers FC1 and FC2 with the locations of the electrode tab centers TC1 and TC2. Through this, the controller 500 may determine the alignment state of the battery cell 300.

The controller 500 may transmit a second signal SIG2 to the notification unit 600. The second signal SIG2 may include alignment status information of the battery cell 300 or the optical system 400.

The notification unit 600 may deliver the alignment status information of the battery cell 300 or the optical system 400 to a user. The user may adjust the location of the battery cell 300 or the optical system 400 based on the alignment status information of the battery cell 300 or the optical system 400.

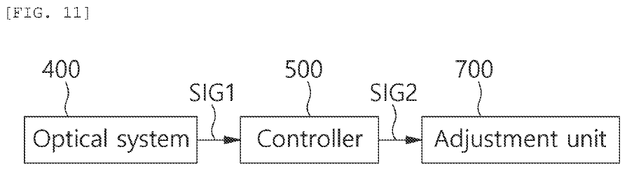

FIG. 11 is a block diagram illustrating the optical system 400, the controller 500, and an adjustment unit 700 according to an embodiment of the present disclosure. The alignment device may include the adjustment unit 700.

Unlike shown in FIG. 10, the controller 500 may transmit the second signal SIG2 to the adjustment unit 700. The adjustment unit 700 may adjust the location of the battery cell 300 or the optical system 400 based on the second signal SIG2.

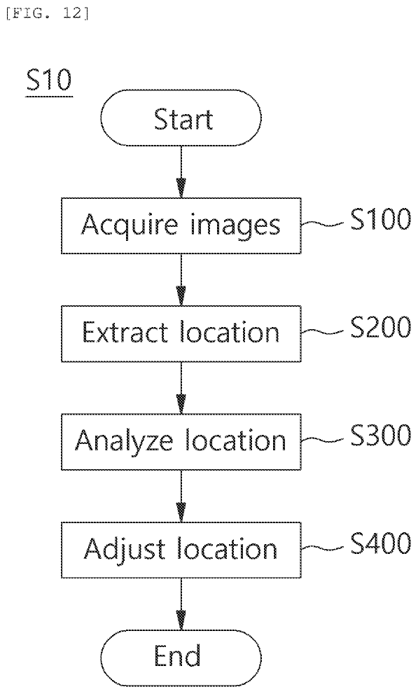

Hereinafter, an alignment method using the carrier 200 will be described with reference to FIGS. 1 to 11. FIG. 12 is a flowchart illustrating an alignment method (S10) according to an embodiment of the present disclosure.

The alignment method (S10) may include an image acquisition step (S100). In this step (S100), the optical system 400 may acquire images of the carrier 200 and the battery cell 300.

In this step (S100), the first optical system 400A may acquire images of the left side of the carrier 200 and the left side of the battery cell 300. In this step (S100), the first optical system 400A may acquire images within the first FOV 410A.

In this step (S100), the second optical system 400B may acquire images of the right side of the carrier 200 and the right side of the battery cell 300. In this step (S100), the second optical system 400B may acquire images within the second FOV 410B.

The alignment method (S10) may include a location extraction step (S200). In this step (S200), the controller 500 may extract the location of the marking member 220. In this step (S200), the controller 500 may extract the locations of edges of the marking member 220. In this step (S200), the controller 500 may extract the locations of the electrode tab centers TC1 and TC2.

The alignment method (S10) may include a location analysis step (S300).

In this step (S300), the controller 500 may analyze the location of the marking member 220. If at least a portion of the marking member 220 moves out of the FOV 410, it may be determined that the alignment state of the optical system 400 is an abnormal state. At this time, the optical system 400 may analyze a moved distance or a rotated angle compared to the normal state according to the direction and distance in which the marking member 220 deviates.

In this step (S300), the controller 500 may analyze the locations of the edges of the marking member 220. If the outer edges of the marking member 220 overlap with the boundaries of the FOV 410, it may be determined that the alignment state of the optical system 400 is a normal state.

If the outer edges of the marking member 220 do not overlap with the boundaries of the FOV 410, it may be determined that the alignment state of the optical system 400 is an abnormal state. At this time, by analyzing a difference between the locations of the outer edges of the marking member 220 and the locations of the boundaries of the FOV 410, the distance that the optical system 400 is moved compared to the normal state may be analyzed.

If the edge of the marking member 220 forms an angle with the boundary of the FOV 410, it may be determined that the alignment state of the optical system 400 is an abnormal state. At this time, by analyzing the angle formed between the edge of the marking member 220 and the FOV 410, the angle at which the optical system 400 is rotated compared to the normal state may be analyzed.

In this step (S300), the controller 500 may analyze the locations of the electrode tab centers TC1 and TC2. If the electrode tab centers TC1 and TC2 overlap with the FOV centers FC1 and FC2, it may be determined that the alignment state of the battery cell 300 is a normal state. For example, if the first electrode tab center TC1 overlaps with the first FOV center FC1 and the second electrode tab center TC2 overlaps with the second FOV center FC2, it may be determined that the alignment state of the battery cell 300 is a normal state.

If the electrode tab centers TC1 and TC2 do not overlap with the FOV centers FC1 and FC2, it may be determined that the alignment state of the battery cell 300 is an abnormal state. For example, if the first electrode tab center TC1 does not overlap with the first FOV center FC1 or the second electrode tab center TC2 does not overlap with the second FOV center FC2, it may be determined that the alignment state of the battery cell 300 is an abnormal state. At this time, by analyzing the difference between the locations of the electrode tab centers TC1 and TC2 and the locations of the FOV centers FC1 and FC2, the moved distance or the rotated angle of the battery cell 300 compared to the normal state may be analyzed.

The alignment method (S10) may include an adjustment step (S400). In this step (S400), the controller 500 may control the adjustment unit 700 based on results analyzed in the previous step (S300). The adjustment unit 700 may adjust the location of the optical system 400. Thereby, the alignment state of the optical system 400 may be the normal state. The adjustment unit 700 may adjust the location of the battery cell 300. Thereby, the alignment state of the battery cell 300 may be the normal state.

The contents described above are merely an example to which the principles of the present disclosure are applied, and other configurations may be further included in the present disclosure without departing from the scope thereof.

### DESCRIPTION OF REFERENCE NUMERALS

10: Equipment
100: Rail
200: Carrier
210: Carrier body
211: Carrier left end
212: Carrier right end
213: Carrier front end
214: Carrier rear end
220: Marking member
230: First marking member
240: Second marking member
250: Third marking member
251: Third marking member left end
252: Third marking member right end
253: Third marking member front end
254: Third marking member rear end
255: First FIG.
256: Second FIG.
260: Fourth marking member
300: Battery cell
310: Cell body
320: Electrode tab
321: First electrode tab
322: Second electrode tab
400: Optical system
400A: First optical system
400B: Second optical system
410: FOV
410A: First FOV
410B: Second FOV
412B: Second FOV right end
413B: Second FOV front end
500: Controller
600: Notification unit
700: Adjustment unit
FC1: First FOV center
FC2: Second FOV center
TC1: First electrode tab center
TC2: Second electrode tab center
D1: First distance
D2: Second distance
RP: Reference point

What is claimed is:

1. An alignment device comprising:
a carrier; and
an optical system disposed above the carrier to acquire an image of an upper surface of the carrier within a field of view (FOV),
wherein the carrier comprises:
a carrier body formed to extend in a left-right direction; and
a marking member disposed on an upper surface of the carrier body,
wherein edges of the marking member are formed so that at least a portion thereof overlaps with boundaries of the FOV in a normal state, and
the normal state is a state where the optical system is located at a preset location with respect to the carrier.

2. The alignment device according to claim 1, comprising a plurality of optical systems which comprise:
a first optical system which forms a first FOV; and
a second optical system which forms a second FOV,
wherein the first FOV is a region arranged on a left side of the carrier, and
the second FOV is a region arranged on a right side of the carrier.

3. The alignment device according to claim 2, comprising a plurality of marking members which comprise:
a first marking member and a second marking member included in the first FOV when the optical system is in the normal state; and
a third marking member and a fourth marking member included in the second FOV when the optical system is in the normal state.

4. The alignment device according to claim 3, wherein edges of the first marking member overlap with a left end and a front end of boundaries of the first FOV when the optical system is in the normal state,
edges of the second marking member overlap with the left end and a rear end of the boundaries of the first FOV when the optical system is in the normal state,
edges of the third marking member overlap with a right end and a front end of boundaries of the second FOV when the optical system is in the normal state, and
edges of the fourth marking member overlap with the right end and a rear end of the boundaries of the second FOV when the optical system is in the normal state.

5. The alignment device according to claim 1, wherein the marking member is disposed to be spaced apart from a periphery of the upper surface of the carrier body.

6. The alignment device according to claim 1, wherein the marking member includes unit figures of a first figure type and unit figures of a second figure type, which have different brightness and are arranged in a shape of a checkerboard.

7. The alignment device according to claim 1, comprising a battery cell mounted on the upper surface of the carrier,
wherein the battery cell comprises:
a cell body; and
an electrode tab which protrudes from a left side or right side of the cell body,
wherein a center of the electrode tab overlaps with a center of the FOV in the normal state, and
the normal state further includes a state where the battery cell is located at a preset location with respect to the carrier.

8. The alignment device according to claim 7, wherein the electrode tab is formed symmetrically in a front-back direction with respect to a center line extending in a left-right direction and crossing the center of the electrode tab, and
the battery cell comprises a plurality of cell marking members arranged symmetrically in the front-back direction with respect to the center line.

9. The alignment device according to claim 1, comprising a controller configured to derive an alignment state of the optical system with respect to the carrier by analyzing the image.

10. The alignment device according to claim 9, comprising a notification unit configured to receive the alignment state of the optical system from the controller and notify the alignment state of the optical system to a user.

11. The alignment device according to claim 9, comprising an adjustment unit configured to receive the alignment state of the optical system from the controller and adjust a location of the optical system.

12. An alignment method comprising:
an image acquisition step of, by an optical system, acquiring an image of a carrier;
a location extraction step of, by a controller, extracting a location of a marking member of the carrier from the image;
a location analysis step of, by the controller, determining an alignment state of the optical system by analyzing the location of the marking member compared to boundaries of a field of view (FOV) of the optical system; and
an adjustment step of, by an adjustment unit, adjusting the location of the optical system according to the alignment state of the optical system,
wherein the alignment state of the optical system comprises:
a normal state where the optical system is located at a preset location with respect to the carrier; and
an abnormal state where the optical system deviates from the preset location with respect to the carrier.

13. The alignment method according to claim 12, wherein in the location analysis step,
if at least a portion of the marking member deviates from the boundary, the controller determines the alignment state of the optical system as the abnormal state.

14. The alignment method according to claim 12, wherein in the location analysis step,
the controller analyzes a difference between locations of boundaries and the locations of edges of the marking member to determine a distance that the optical system is moved compared to the normal state.

15. The alignment method according to claim 12, wherein in the location analysis step,
the controller analyzes am angle formed by the boundary and the edge of the marking member to determine an angle at which the optical system is rotated compared to the normal state.

16. The alignment method according to claim 12, wherein the marking member includes unit figures of a first figure type and unit figures of a second figure type, which have different brightness and are arranged in a shape of a checkerboard, and
in the location analysis step, the controller analyzes the locations of the boundaries compared to the locations of the unit figures of the first figure type and the unit figures of the second figure type.

17. The alignment method according to claim 12, wherein in the image acquisition step, the optical system acquires an image of a battery cell mounted on a surface of the carrier,
wherein the battery cell comprises:
a cell body; and
an electrode tab which protrudes from the cell body and is included within the FOV in the normal state.

18. The alignment method according to claim 17, wherein in the location extraction step, the controller extracts a location of a center of the electrode tab from the image of the battery cell, and
in the location analysis step, the controller determines an alignment state of the battery cell by analyzing the location of the center of the electrode tab compared to a location of a center of the FOV.

19. The alignment method according to claim 18, wherein in the location analysis step, the controller analyzes a difference between the location of the center of the FOV and the location of the center of the electrode tab to determine a moved distance or a rotated angle of the battery cell compared to the normal state.

20. The alignment method according to claim 17, wherein the electrode tab is formed symmetrically in a front-back direction with respect to a center line extending in a left-right direction and crossing the center of the electrode tab, and
the battery cell comprises a plurality of cell marking members arranged symmetrically in the front-back direction with respect to the center line,
wherein in the location extraction step, the controller extracts a location of the marking member from the image of the carrier, and
in the location analysis step, the controller derives a location of the center line, analyzes the location of the center line compared to the location of the center of the FOV, and determines an alignment state of the battery cell.
